(19) United States
(12) Patent Application Publication
(10) Pub. No.: US 2004/0250389 A1
(43) Pub. Date: Dec. 16, 2004

(54) Transitional stylized casket cover and body shroud, and process for fabrication and installation thereof

(76) Inventors: Millie A. Hooper, Sunbright, TN (US); Sally M. Armes, Petros, TN (US)

Correspondence Address: M. Alex Brown, Esq., Patent Attorney, P.O. Box 70501, Knoxville, TN, 37938-0501, US

(21) Appl. No.: 10/461,584

(22) Filed: Jun. 14, 2003

(51) Int. Cl. A61G 17/00

(52) U.S. Cl. 27/19

(57) ABSTRACT

A divisible and separable full half-portion casket cover and body veil or shroud and the process for its fabrication and installation is disclosed. The casket cover and body shroud is provided with a dimensioned base member suitable for properly fitting the several types of conventional burial caskets used in the funeral industry and an extension member which attaches to the base of the invention generally at the boundary on the casket between an open and closed lid half section of the casket; and extends from its connection down into the casket to provide a vertically oriented walln. After a funeral, or upon burial, the extension is detached from the base and utilized as a veil or shroud-like member in relation to the body of a deceased person in the casket.

### DETAILED DESCRIPTION OF THE PREFERRED EMBODIMENTS OF THE INVENTION

The following description of the preferred embodiments of the concepts and teachings of the present invention is made in reference to the accompanying drawing figures which constitute preselected illustrated examples and schematic representations of the elements of the present invention, among many other examples existing within the scope and spirit of the present invention.

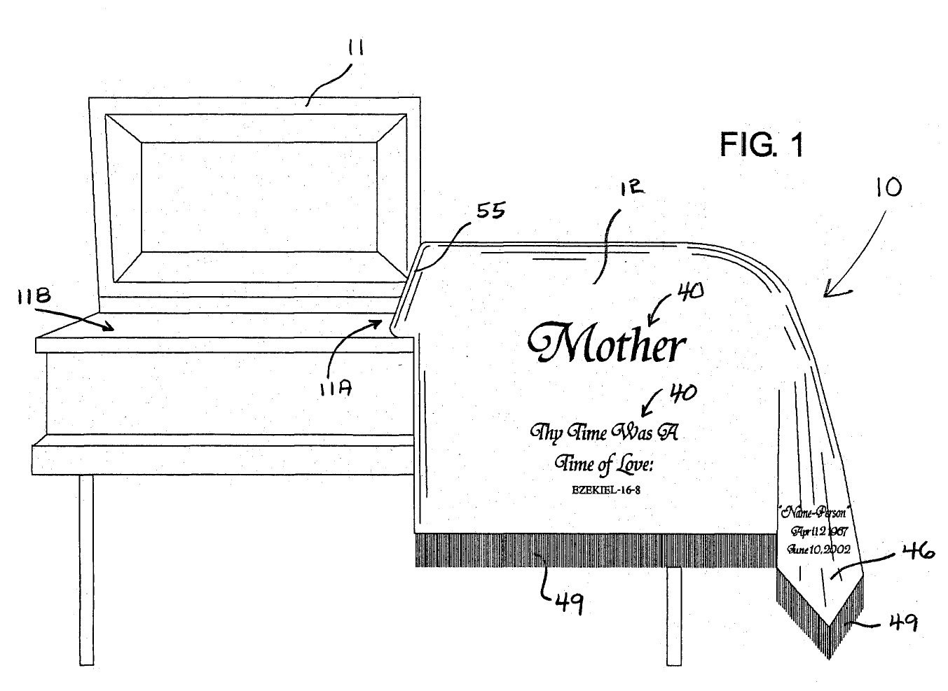

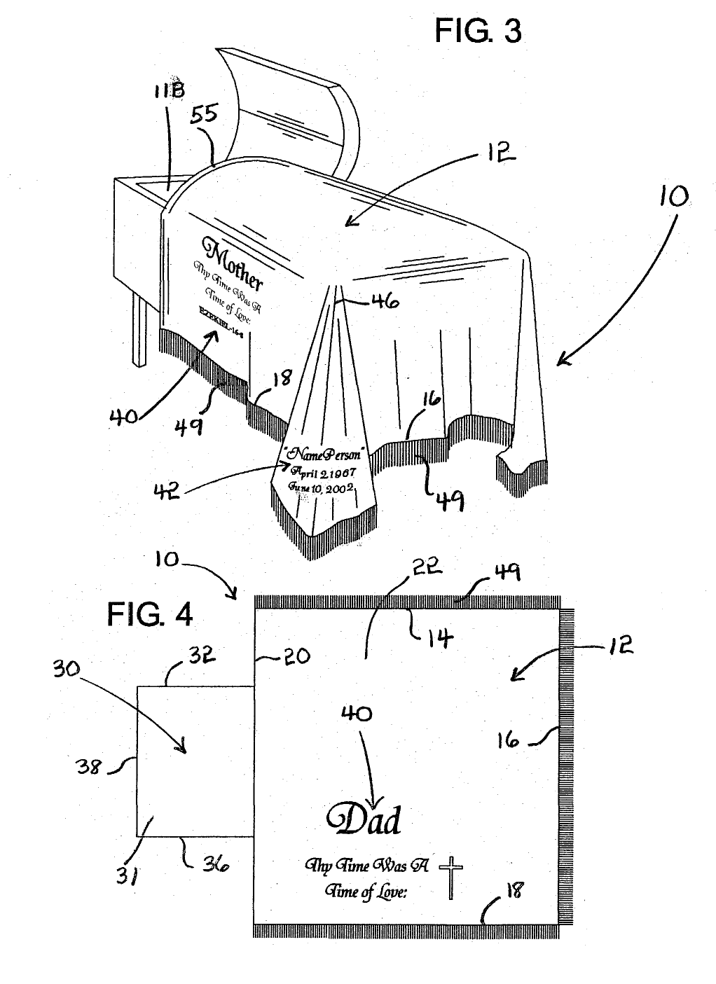

Referring now to the drawings, FIGS. 1 through 5B, thereof, there is shown a Divisible Burial Casket Cover and Body Shroud 10 of the present invention also referred to herein as the Divisible Casket Drapery Cover 10 or Cover 10.

The Cover 10 is utilized in interaction with a burial casket or coffin 11 in preparing a casket and the deceased for public viewing during a funeral service, wake, vigil or other public or private gathering for paying ‘last respects’ to a deceased person; and as a body shroud, veil or covering when the Cover 10 is separated for that purpose after a funeral and in preparation for burial, as set forth in greater detail herein.

The base member 12 of the present invention is made up of at least two sides; and preferably first, second, third and fourth sides; 14, 16, 18 and 20, respectively. The base 12 also has an external surfacing 22 and internal surfacing 24. The base member 12 and the extension member (discussed in detail later herein) are preferably made, constructed or fabricated of flexible and positionable materials including, without limitation: Faux fur, satin, velvet, flannel, silk or linen. However, it will be understood by those skilled in the art that a number of other flexible or malleable materials, fabrics and substances, and artificial or synthetic derivations thereof can be utilized in constructing the present invention, for the specific functions and use of the present invention in relation to a burial casket/coffin and a deceased person's body.

In preferred embodiments, the fourth side 20 of the base 12 is provided with the first engaging complimentary part 26 of a connection system 25 between the base 12 and the extension 30 (discussed below).

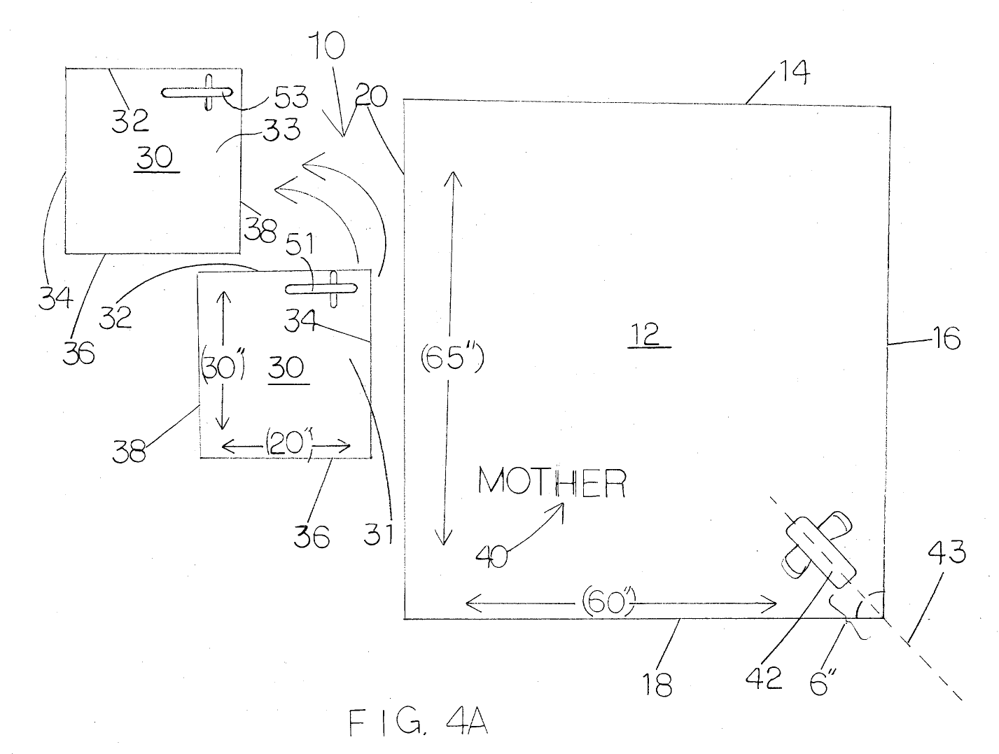

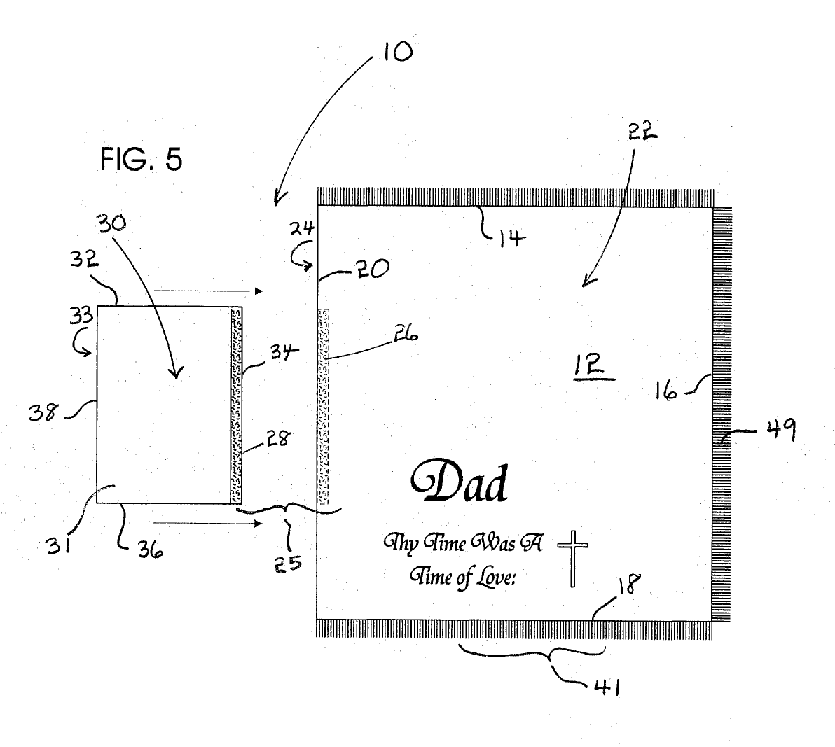

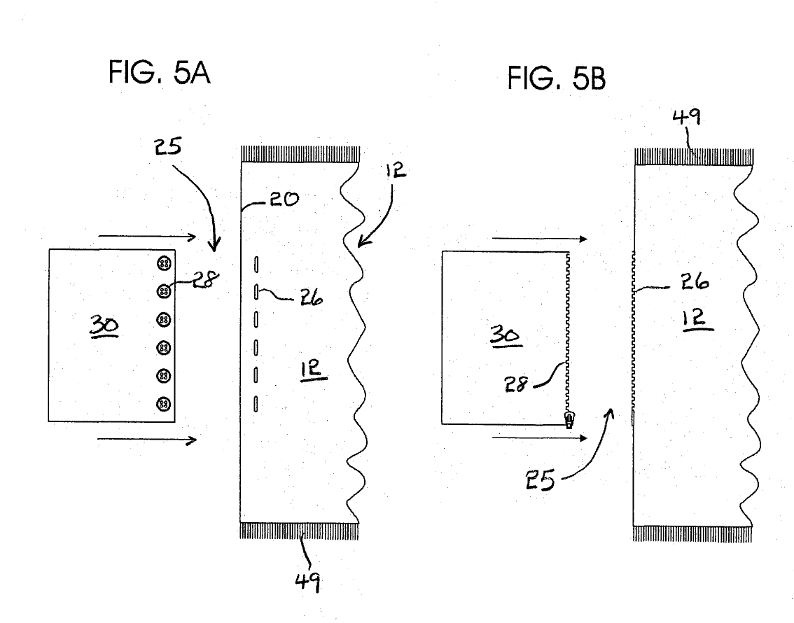

The base 12 further includes the extension member 30 (or remnant member 30), which is provided with at least two sides; but is preferably provided with first, second, third and fourth sides, 32, 34, 36 and 38, respectively, as shown in FIGS. 4 and 5. In preferred embodiments the extension 30 is provided with complementary part 28 of the connection system 25, on one of its sides, such as the second side 34, as illustrated, for releasable attachment to the complementary part 26 of the base 12.

The extension 30 of the Cover 10 of the present invention is functionally employed as a part of the scope and spirit of the invention in two positionable orientations or arrangements; as encompassed or anticipated in serving the invention's functions before, during and after a funeral service, public viewing (of the deceased person) or similar related funeral-oriented activities.

In one positional arrangement prior to or during a funeral function the extension 30 is attached to the base member 12 by means or types of attachment or securement systems including, without exemplar limitation, complementing parts of a hook and loop (Velcro(R)) system, a zipper or zipper-like system, a snap-and-attachment (male/female) system, or a button-and-button hole system. In this regard, see FIGS. 5, 5A and 5B. However, it will be understood that a number of attachment systems can be utilized, within the scope of the present invention, to secure the extension 30 to the base 12 in such a way that it can be conveniently and/or quickly released and detached from the base 12.

In another positional arrangement the extension 30 is separated from the base member 12 (See FIG. 5); and made available during or after a funeral activity to be positioned on or in positional relation to a deceased person in a casket 11 as a cover, robe, veil or at least a partial shroud. Additionally, in accordance with the desires of the family, etc., of a deceased person, the extension member, once separated, can be partitioned (divided) and given in its divided parts to family members, etc., as a ‘keepsake’ or object of memory of the person's funeral or past life.

After separation form the extension member 30 the base 12 is taken from about the burial casket 11 (after a funeral or related event), and packaged and folded in a container so that an embroidered and/or stitched portion (discussed herein, below) is ‘windowed’, exhibited or ‘show-cased’ to display the figure, emblem and/or script appearing as a part of the base 12.

In this regard, several elements or portions of embellishment and/or ornamentation are positionally located, within the scope and spirit of the present invention, in preferred embodiments, for special exhibit and showcase when the base 12 and/or extension 30 is positioned about a casket or coffin 11, as illustrated by example in FIGS. 1 through 3.

Accordingly, as shown, by example only, in FIGS. 4 and 5; a first embroidered and/or stitched portion 40 is attached to or created on the external surfacing 22 of the base 12 at a position or location, in preferred embodiments, along a middle portion 41 between the second side 16 and fourth side 20 of the base 12 at an area also proximate or proximal to the third side 18 of the base 12; and in some of the preferred embodiments of the present invention will be located somewhat closer to the fourth side 20, than the second side 16 of the base 12, as shown by example in FIG. 4.

Other preferred embodiments will comprise the first portion 40; and additionally, be provided with the second embroidered/stitched portion 42. The second portion 42 is preferably located and positioned on the external surfacing 22, between or proximately between, the second side 16 and the third side 18, along an imaginary axis line 43 generally splitting the angle alpha between the second (16) and third (18) sides of the base 12 at the intersection of these sides; shown schematically, by example, in FIG. 4a. In the example therein a ‘cross’ embroidery is shown about six (6) inches (in accordance with that general scale) from the intersection of the second and third sides, 16 and 18, along axis line 43.

In preferred embodiments, the base 12 is further provided with the cantilevered drapery portion 46; as shown, by example, in FIGS. 1, 2 and 3. The drapery portion 46 is folded so that this portion 46 hangs loosely down from a cantilevered point between the first (14) and third (18) sides of the base 12; when the base 12 is positioned on or about a casket 11, as shown by example in the illustrations (FIGS. 1-3). The portion 46 is also pre-stitched, pre-folded and secured or pre-positioned and supported on the base 12, in embodiments of the invention, so that the portion 46 will fall or be more easily guided into position when the base 12 is placed over a casket 11.

Additionally, the first (14), second (16) and third (18) sides of the base 12 are provided with decorative trim portions 49; as shown by example, in FIGS. 1 through 5.

The exterior (31) surfacing of the extension 30 is provided with an embroidered or stitched portion 51. The interior surfacing 33 of the extension 30 is also provided with the embroidered or stitched portion 53, as an alternative embodiment when it is desired to simply pull the extension member 30 back onto a deceased person in a casket 11 when the extension 30 is separated from the base 12, during or after a funeral service function or program; and, in so doing, have the portion 53 already in a viewable position, facing outward, so that it can be viewed by those present. Each of the embroidered or stitched portions 53, 51, and 40 and 42 is provided as a three-dimensional stitched emblem, figure and/or script, although others, more two-dimensional in view, can be utilized.

Preferred embodiments within the scope of the present invention also include the method or process of making and installing the Burial Casket Cover and Body Shroud 10; in multi-positional interaction in relation to a casket 11 which is elevated on a support for viewing, as is frequently done in funeral homes and like facilities. The casket 11 is illustrated by example, in this manner, in FIGS. 1, 2 and 3. In this regard it is conventionally customary to place a casket 11 at an elevation of at least about 21 inches from a ground surface for viewing.

At times, this elevation has varied, based on the funeral facilities available, from about 2 feet to about 3 feet. Dimensionally speaking, it has been found to be advantageous in preferred embodiments to dimension the base 12 so that it will hang from about 4 inches to about 8 inches below a bottom portion (or surface) of a casket 11 when it is conventionally elevated as indicated. Depending, however, on the size of a casket 11 utilized, the dimensions of the Cover 10 will vary so that the present invention will fit over a casket 11 chosen for use; and extend down below a bottom portion or surface of a casket 11, to effectively cover and ornament a casket. This is illustrated, by example, in FIGS. 1-3. An example only of a preferred embodiment of the base 12, utilized in relation and interaction, or in combination, with an average or conventionally sized casket would include dimensions where the first and third sides, 14 and 18, are from about 58 to about 62 inches; and where the second and fourth sides, 16 and 20, are from about 61 inches to about 66 inches. Exemplar dimensions for the extension 30 are from about 18 to about 22 inches as to the first and third sides, 32 and 36; and from about 28 inches to about 32 inches as to the second and fourth sides, 34 and 38; as indicated, generally, scale-wise, or schematically, in FIGS. 4, 4a and 5, by example only. It will be understood that scale and dimensions will vary within the scope of the invention in relation to the size of the casket 11 utilized.

The process of the present invention by which the Cover 10 of the invention is the product thereof, further includes positioning and installing the base 12 over or about a closed half-portion 11A of a casket 11, elevated as discussed, to cover this portion of the casket as indicated. The base 12 is installed over a half-portion 11A of a casket 11, as illustrated, so that the cantilevered drapery portion 46 is formed over a corner of a casket 11, as shown by example in FIGS. 1-3 and discussed earlier.

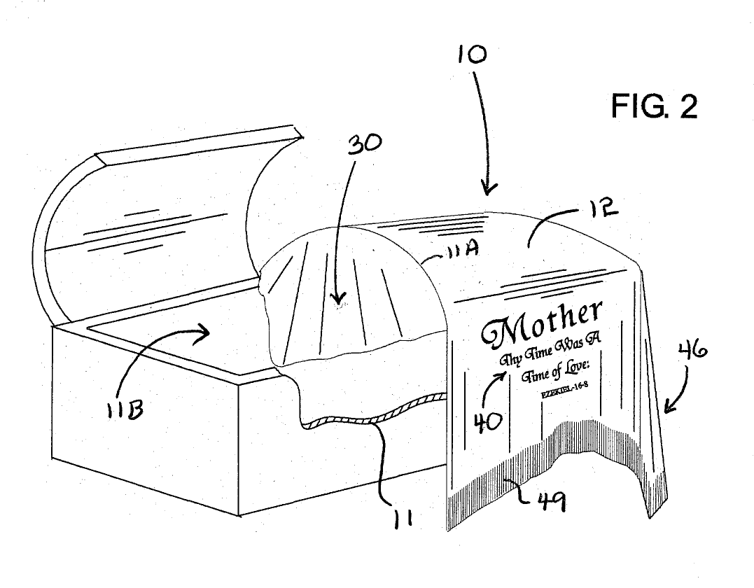

The process further includes fabricating and dimensioning the extension 30 so that it will fit and extend, when connected to the base 12, from the base 12; shown by example as the crimped area 55 where the base 12 and extension 30 connect at about the boundary of a closed half-portion 11A of a casket 11; to a preselected positional depth within an open half-portion 11B of a casket, as illustrated by example in FIG. 2.

The process then further includes or comprises detaching the extension 30 from the base 12, by opening the connection system 25, and separating or dividing the extension 30 from the base 12. The extension 30 is then placed or positioned, as discussed earlier in part, within the casket 11 with which it interacts so that it is left as a keepsake or remnant of memory, or the like, in a position covering or veiling part of the deceased person (such as the face or thoracic area); or otherwise placed in a position adjacent to a portion of a deceased person lying in a casket 11. The casket 11 is then sealed or closed for burial, leaving the extension member 30 therein, to be buried with the casket 11.

Additionally, the scope and spirit of the Cover 10 of the present invention, both as to process and product (or structural item) taught herein includes, in other embodiments thereof, a number of types of shapes or design configurations that the base 12 and extension 30 can be fabricated in; including elliptical, arcuate, round or circular, trapezoidal, parallelogram-like, parabola-like; and in other arcuate or linear geometric shapes and configurations; in each case, being fabricated dimensionally to fit over the closed half-section 11B of a casket 11, with the extension 30 being positioned as discussed within the open half-portion 11A of the casket 11, with the positioning and utilization of a crimped area 55, as an indication of boundary between half-portions 11A and 11B of a casket 11.

Accordingly, the appended claims are intended to cover all changes, modifications and alterative options and embodiments falling within the true breath, scope and spirit of the present invention and Cover 10; and process thereof for making and installing the invention. The reader is, therefore, requested to determine the scope of the present invention by the appended claims and their legal equivalents; and not by the examples which have been given.

We claim:

1. A divisible casket cover and body shroud for use in interaction with a casket or coffin in preparation for, during and after a funeral service, said divisible casket cover and body shroud comprising:
a base member, for positionable interaction with and covering of a top portion of a casket, having first, second, third and fourth sides, and positionably external and internal surfacing, said second and fourth sides being configured opposite to and spaced from one another, the fourth side having means, along a portion thereof, for engaging, and attachment to, an independent surface; and
extension means attachable to and releasable from the means of the fourth side of the base member for transitional attachment thereto from a first positional arrangement, when the base member is covering a top portion of a casket, to simulate a vertically oriented wall and continuous surface extending from the fourth side of the base member into a casket; to a second positional arrangement, after a funeral service, when said extension means is divisible and releasable from the fourth side of the base member and stored and positioned as a body shroud or veil within a casket covering a deceased person when the casket is closed or sealed for burial, said extension means having at least first and second sides.

2. The divisible casket cover and body shroud of claim 1, wherein:
the base member further comprises a cantilevered drapery portion defined and supported by portions of the second and third sides thereof and proximate portions of the positionably external and internal surfacing therebetween.

3. The divisible casket cover and body shroud of claim 1, wherein:
the first, second and third sides of the base member have a decorative trim portion attached thereto and extending therefrom.

4. The divisible casket cover and body shroud of claim 1, wherein:
the positionable external surfacing of the base member defines and comprises a first embroidered portion positioned generally in an area thereon located generally about half-way between the second and fourth sides, and generally proximate to the third side of the base member.

5. The divisible casket cover and body shroud of claim 4, wherein:
the positionable surfacing of the base member defines and further comprises a second embroidered portion positioned generally in an area thereon adjacent to the intersection of the second and third sides of said base member.

6. The divisible casket cover and body shroud of claim 1, wherein:
the means of the fourth side of the base member being an engaging part of a loop and hook system; and
the extension means having a complimentary engaging part of a loop and hook system, fixedly positioned on one of the sides thereof.

7. The divisible casket cover and body shroud of claim 1, wherein:
the means of the fourth side of the base member being an engaging part of a zipper system; and
the extension means having a complimentary engaging part of a zipper system.

8. The divisible casket cover and body shroud of claim 1, wherein:
the means of the fourth side of the base member being an engaging part of a snap and detachment system; and
the extension means having a complementary engaging part of a snap and attachment system.

9. The divisible casket cover and body shroud of claim 1, wherein:
the means of the fourth side of the base member defining and having an engaging part of a button-and-button hole attachment system; and
the extension means having a complimentary engaging part of a button-and-button hole attachment system.

10. The divisible casket cover and body shroud of claim 1, wherein:
the extension means comprises first, second, third and fourth sides, and positionable exterior and interior surfacing, the second side having an attachment surface complimentary to and engagable with the means of the fourth side of the base member.

11. The divisible casket cover and body shroud of claim 10, wherein:
the positionable exterior surfacing of the extension means defines and has an embroidered portion thereon.

12. The divisible casket cover and body shroud of claim 11, wherein:
the positionable interior surfacing of the extension means defines and has an embroidered portion thereon.

13. The divisible casket cover and body shroud of claim 11, wherein:
the embroidered portion of the positionable exterior surfacing of the extension means defines and has three-dimensional stitchery.

14. The divisible casket cover and body shroud of claim 12, wherein:
the embroidered portion of the positionable interior surfacing defines and has three-dimensional stitchery.

15. The divisible casket cover and body shroud of claim 5, wherein:
the first and second embroidered portions of the positionable external surfacing of the base member, each, defining and having three-dimensional stitchery.

16. A divisible casket cover and body shroud for use in interaction with a casket or coffin in preparation for, during and after a funeral service, said divisible casket cover and body shroud comprising:
a base member having first, second, third and fourth sides, said second and fourth sides being positioned generally opposite to, and spaced from, one another, the fourth side having engaging means along a portion thereof for attachment to an independent surface; and
a detachable remnant member having at least first and second sides, said first side having engaging means for corresponding attachment with the engaging means of the fourth side of the base member, when positioned on a casket; and being releasable and divisible from the base member for installation within a casket as a body shroud when the casket is closed for burial.

17. The divisible casket cover and body shroud of claim 16, wherein:
the base member further comprises a cantilevered drapery portion defined and supported by portions of the second and third sides thereof and proximate portions of the positionably external and internal surfacing therebetween.

18. The divisible casket cover and body shroud of claim 16, wherein:
the base member further comprises trim portions positioned along at least one of the sides thereof.

19. The divisible casket cover and body shroud of claim 18, wherein:
the base member further comprises at least one embroidered portion.

20. The divisible casket cover and body shroud of claim 19, wherein:
the detachable remnant member further comprises at least one embroidered portion.

21. A process for fabricating and installing a separable casket cover for multi-positional interaction in relation to an elevated and supported burial casket having first and second half-portion covers, for use in preparation for, during and subsequent to a funeral service, said process comprising:
fabricating and dimensioning a first flexible member having at least first and second sides, such that it will installably and fitably extend below a bottom surface of an elevated and supported burial casket;
positioning and installing the first member over and about a closed half-portion cover of an elevated burial casket such that a cantilevered drapery portion extends loosely down a corner of such an elevated burial casket;
fabricating and dimensioning a second flexible member such that it will fitably extend from one of the at least first and second sides of said first flexible member to a variable preselected positional depth within an open half-portion of an elevated casket; and
releasably and divisibly attaching the second flexible member to the first flexible member and installing the second flexible member in a vertically oriented positional configuration extending from the first flexible member to the variable preselected positional depth, for positioning as a vertically oriented wall extending therebetween.

22. The product of the process of claim 21.

23. The process of claim 21, wherein:
said process further comprises:
detaching the first flexible member from the second flexible member and separating it therefrom;
positioning the detached and separated second flexible member within a burial casket such that it is adjacent to a portion of a deceased person lying therein: and
sealing or closing such a burial casket and leaving the detached and separated second flexible member therewithin as a cover lying over a deceased person in a casket for burial.
